(19) United States
(12) Patent Application Publication
(10) Pub. No.: US 2014/0323039 A1
(43) Pub. Date: Oct. 30, 2014

(54) METHOD AND APPARATUS FOR CONTROLLING VEHICLE COMMUNICATION

(71) Applicants: Infobank Corp., Seongnam-si (KR); INTELLECTUAL DISCOVERY CO., LTD., Seoul (KR)

(72) Inventors: Jong Cheol HONG, Seoul (KR); Won JANG, Seongnam-si (KR)

(73) Assignees: INTELLECTUAL DISCOVERY CO., LTD., Seoul (KR); INFOBANK CORP., Seongnam-si (KR)

(21) Appl. No.: 14/263,296

(22) Filed: Apr. 28, 2014

(30) Foreign Application Priority Data
Apr. 29, 2013 (KR) 10-2013-0047715
Apr. 29, 2013 (KR) 10-2013-0047722

(51) Int. Cl. H04B 7/24

(52) U.S. Cl. CPC H04B 7/24
USPC 455/39

(57) ABSTRACT

Provided is a terminal supporting in-vehicle wireless communication, wherein the terminal may include a wireless communication unit to establish a wireless connection to a vehicular system, a sensor unit to verify a predetermined state of the terminal when the wireless connection is maintained, and a controller to control the wireless communication unit to maintain or cancel the wireless connection based on the state of the terminal.

### CROSS-REFERENCE TO RELATED APPLICATION

This application claims the priority benefit of Korean Patent Application No. 10-2013-0047715, filed on Apr. 29, 2013, and Korean Patent Application No. 10-2013-0047722, filed on Apr. 29, 2013, in the Korean Intellectual Property Office, the disclosures of which are incorporated herein by reference.

### BACKGROUND

1. Field of the Invention

The present invention relates to a method and an apparatus for controlling vehicle communication, and more particularly, to a method and an apparatus for controlling vehicle communication that may ease inconvenience caused when a mode of connection between a vehicle and a terminal is changed.

2. Description of the Related Art

Automobiles have become a necessity for those living in the modern era as can be seen by an ever increasing number of automobiles on the road. Accordingly, demands for convenient services related to automotive repair and maintenance have been increasing.

With the development of automotive technologies, important components of the newest automobile models are being electronically controlled. Also, devices that may provide various services to drivers of vehicles have been developed and commercialized because such devices may electronically control various automotive components and obtain a variety of information on vehicles.

For example, an automobile multimedia device may include an audio, video, navigation (AVN) head unit supporting a handsfree call mode in the vehicle.

The automobile multimedia device may support the handsfree call mode when a mobile phone equipped with a Bluetooth function possessed by a driver is connected to the automobile multimedia device. To support the handsfree call mode, the automobile multimedia device may include a short range communication unit, for example, Bluetooth, and a controller to control the short range communication unit. Thus, the driver may conveniently make or receive a call in the handsfree mode.

A radio frequency (RF) specification for a Bluetooth device applied to an audio/AVN system is identical to an RF specification for a Bluetooth device applied to a mobile phone, which is Power Class 2. The RF specification of the Power Class 2 requires −6 decibel-milliwatts (dBm) through +4 dBm for a transmitter and less than or equal to −70 dBm for a receiver. Thus, communication may be available within a communication range of approximately 10 meters (m).

In general, the Bluetooth device currently used for a vehicle may not control the communication range from a counterpart of the driver during a call and transmission output. Conversely, mobile phone companies may set the communication range of the Bluetooth device to be a maximum in during a manufacturing process.

However, when a paired mobile phone is removed from the vehicle when the driver disembarks while leaving a start button or an ignition key in an on state, the driver may not be able to make or receive calls with the mobile phone because the calls may be transferred to the vehicle in the handsfree call mode, despite the driver being 5 to 30 meters (m) away from the vehicle in a straight line.

As detailed in the foregoing incident, drivers may be inconvenienced due to a difference between a point in time when a handsfree call is connected or cancelled and a point in time when the driver enters or disembarks the vehicle.

Accordingly, technology for automatically transferring the handsfree call has been proposed. However, a method by which a determination as to whether a call is to be transferred based on a strength of a radio wave or a pairing state may involve a transfer delay and thus, a period of time during which the driver is unable to continue with a normal call may occur.

Furthermore, the handsfree function performed through a speaker of the vehicle may continue operating for a period of time even after the driver disembarks and thus, the call may be dropped. Similarly, when the driver enters the vehicle during the call, an immediate transfer of the call to the handsfree made may not be completed with precise timing.

Although a large number of vehicles currently support the Bluetooth handsfree function and handsfree kits are being released with a widespread use of smartphones, the foregoing issues may still remain unresolved thereby further inconveniencing the driver. As such, there is a growing need to solve the issue.

In response to the growing need, various services based on communication between a smartphone and a vehicle have been developed and provided to vehicles. However, an issue associated with user convenience, recognition, and accuracy in operation still requires improvement.

### SUMMARY

An aspect of the present invention provides a method and an apparatus for controlling vehicle communication that may improve user convenience by controlling wireless connection based on a result of verifying a state of electronics of a vehicle and determining a mode change between a handsfree call mode and a general call mode.

Another aspect of the present invention also provides a method and an apparatus for controlling vehicle communication that may be differentiated from existing technologies for communication mode change in terms of accuracy and reducing a delay.

According to an aspect of the present invention, there is provided a terminal supporting in-vehicle wireless communication including a wireless communication unit to establish a wireless connection to a vehicular system, a sensor unit to verify a predetermined state of the terminal when the wireless connection is maintained, and a controller to control the wireless communication unit to maintain or cancel the wireless connection based on the state of the terminal.

The controller may determine whether a driver disembarks a vehicle based on the state of the terminal, and control the wireless communication unit to maintain or cancel the wireless connection based on a result of the determining whether the driver disembarks the vehicle.

The controller may determine a strength of a radio signal of the wireless connection, and control the sensor unit to verify the state of the terminal when the strength of the radio signal is less than or equal to a predetermined value.

Information on the state of the terminal may include information on a sensed motion of the terminal.

The controller may determine that the driver disembarks the vehicle when a degree of a vertical motion of the terminal exceeds a predetermined threshold.

The controller may determine that the driver disembarks the vehicle when a degree of a tilt of the terminal exceeds a predetermined threshold.

The controller may control the wireless communication unit to transmit the information on the state of the terminal to the vehicular system.

The controller may determine the strength of the radio signal of the wireless connection, and control the wireless communication unit to transmit the information on the state of the terminal to the vehicular system when the strength of the radio signal is less than or equal to a predetermined value.

According to another aspect of the present invention, there is provided a vehicular system wirelessly communicating with a terminal including a wireless communication unit to establish a wireless connection to the terminal and receive a predetermined state of the terminal when the wireless connection is maintained, and a controller to control the wireless communication unit to maintain or cancel the wireless connection based on the state of the terminal.

The controller may determine whether a driver disembarks a vehicle based on the state of the terminal, and control the wireless communication unit to maintain or cancel the wireless connection based on a result of the determining whether the driver disembarks the vehicle.

The controller may determine a strength of a radio signal of the wireless connection, and control the wireless connection based on the state of the terminal when the strength of the radio signal is less than or equal to a predetermined value.

Information on the state of the terminal may include information on a sensed motion of the terminal.

The controller may determine that the driver disembarks the vehicle when a degree of a vertical motion of the terminal exceeds a predetermined threshold.

The controller may determine that the driver disembarks the vehicle when a degree of a tilt of the terminal exceeds a predetermined threshold.

The controller may determine the strength of the radio signal of the wireless connection, and control the wireless communication unit to request information on the state of the terminal when the strength of the radio signal is less than or equal to a predetermined value.

According to still another aspect of the present invention, there is provided a vehicular system controlling vehicle communication including a wireless communication unit to establish a wireless connection to at least one neighboring terminal, a sensor unit to verify a predetermined state of electronics of a vehicle when the wireless connection is maintained, and a controller to control the wireless communication unit to maintain or cancel the wireless connection based on the state of the electronics of the vehicle.

The controller may determine whether a driver disembarks the vehicle based on the state of the electronics of the vehicle, and control the wireless communication unit to maintain or cancel the wireless connection based on a result of the determining whether the driver disembarks the vehicle.

The controller may determine a strength of a radio signal of the wireless connection, and control the sensor unit to verify the state of the electronics of the vehicle when the strength of the radio signal is less than or equal to a predetermined value.

The controller may determine whether the driver enters the vehicle based on the state of the electronics of the vehicle, and reattempt to establish the wireless connection based on a result of determining whether the driver enters the vehicle.

The state of the electronics of the vehicle may include at least one of information on a state of doors and seating corresponding to the terminal.

According to embodiments of the present invention, a method and an apparatus for controlling vehicle communication may improve user convenience by determining whether a driver disembarks a vehicle based on a result of verifying a state of electronics of the vehicle and determining whether to change a mode from a handsfree call mode to a general call mode, and vice versa.

Also, according to embodiments of the present invention, a method and an apparatus for controlling vehicle communication may be differentiated from existing mode change technologies by enabling a comprehensive determination based on a strength of a radio signal and thus, reducing battery consumption and delay and improving accuracy.

Further, according to embodiments of the present invention, a method and an apparatus for controlling vehicle communication may be installed in a vehicle as a basic or optional specification, and applied to integrated communication control technology using a smartphone in conjunction with a an automobile manufacturer.

Furthermore, according to embodiments of the present invention, a method and an apparatus for controlling vehicle communication may be provided as a separate module and applied to an automobile kit that may interwork with an audio, video, navigation (AVN) system of a vehicle. The method and the apparatus according to embodiments of the present invention may provide compatibility with a vehicle in which a Bluetooth module is not installed.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an overall system including a terminal according to an embodiment of the present invention;

FIG. 2A is a block diagram illustrating a configuration of a terminal according to an embodiment of the present invention;

FIG. 2B is a block diagram illustrating a configuration of a vehicular system according to an embodiment of the present invention;

FIG. 3 is a flowchart illustrating an operation method of a terminal according to an embodiment of the present invention;

FIG. 4 is a flowchart illustrating an operation method of a terminal according to another embodiment of the present invention;

FIG. 5 is a diagram illustrating an example of a display output by a terminal according to an embodiment of the present invention;

FIG. 6 is a flowchart illustrating an operation method of a vehicular system according to an embodiment of the present invention;

FIG. 7 is a flowchart illustrating an operation method of a vehicular system according to another embodiment of the present invention; and

FIG. 8 is a diagram illustrating an example of a display output by an electronic control unit (ECU) according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

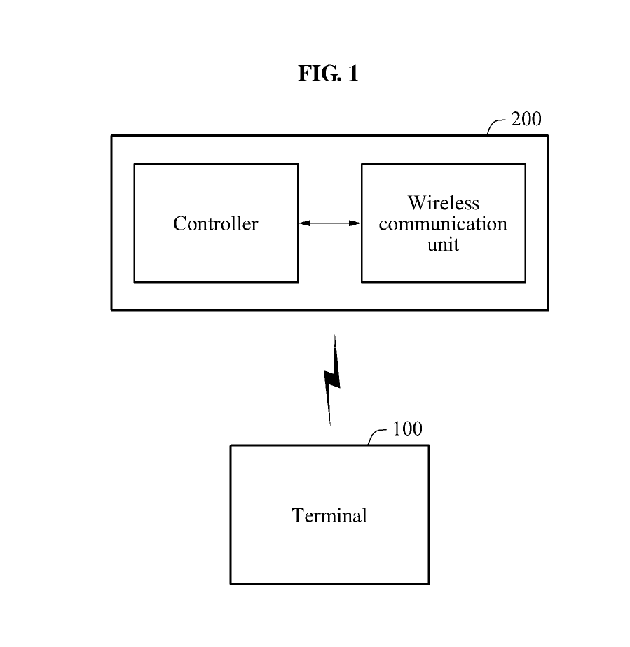

FIG. 1 is a diagram illustrating an overall system including a terminal 100 according to an embodiment of the present invention.

Referring to FIG. 1, the overall system may include the terminal 100 and a vehicular system 200.

The vehicular system 200 may include a controller and a wireless communication unit. The controller may control an operation of the vehicular system 200, and the wireless communication unit may establish a wireless connection to the terminal 100 based on the controlling by the controller.

The terminal 100 and the vehicular system 200 may establish the wireless connection when a user or a driver (the terms “user” and “driver” are interchangeably used herein) enters a vehicle. The wireless connection may be established via a wireless Internet connection or a short range communication.

Technologies for the wireless Internet connection may include a wireless local area network (WLAN), wireless fidelity (WiFi), wireless broadband (WiBro), worldwide interoperability for microwave access (WiMAX), high speed downlink packet access (HSDPA), and the like. Technologies for the short range communication may include Bluetooth, radio frequency identification (RFID), infrared data association (IrDA), ultra wideband (UWB), ZigBee, and the like.

The vehicular system 200 may verify a predetermined state of electronics of the vehicle when a call takes place during the wireless connection. The vehicular system 200 may control the wireless communication unit to maintain or cancel the wireless connection based on the state of the electronics of the vehicle.

The state of the electronics may include at least one of information on a state of doors and seating corresponding to the terminal 100. The vehicular system 200 may determine whether the driver or a passenger enters or disembarks the vehicle based on the information on the state of doors or the seating and accordingly, control the wireless communication unit to maintain or cancel the wireless connection. Also, the vehicular system 200 may determine whether to verify the state of the electronics based on a strength of a radio signal or a communication signal (hereinafter referred to as a “radio signal”) of the wireless connection.

The terminal 100 and the vehicular system 200 that are wirelessly connected to each other may transmit and receive a call signal and a voice signal using a predetermined wireless communication method. Thus, transmission and reception of audio data as in a handsfree mode may occur. The vehicular system 200 may allow the audio data transmitted from and received by the terminal 100 that is wirelessly connected to the vehicular system 200 through a speaker and a microphone included in the electronics of the vehicle to be output to perform a calling function.

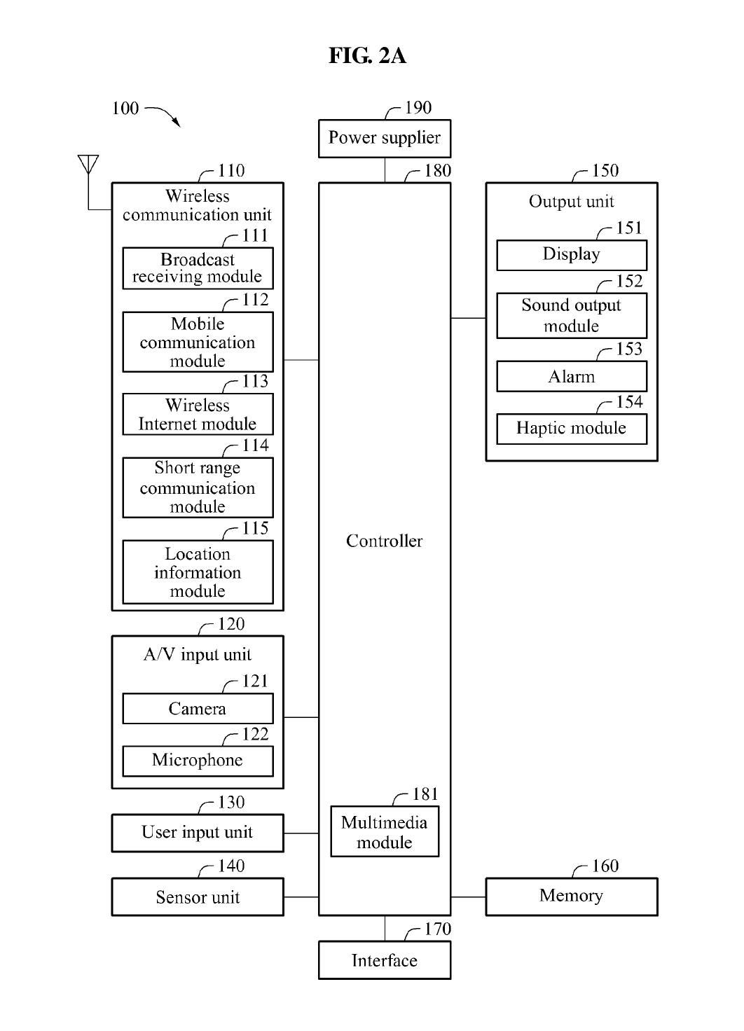

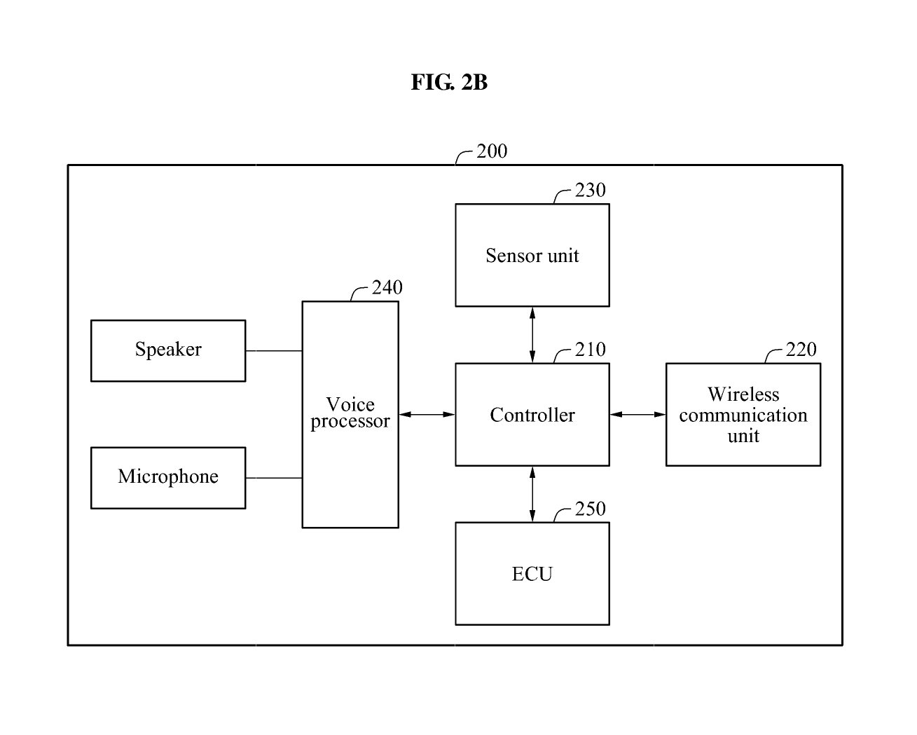

FIG. 2A is a block diagram illustrating a configuration of the terminal 100 according to an embodiment of the present invention.

Referring to FIG. 2A, the terminal 100 may include a wireless communication unit 110, an audio/video (A/V) input unit 120, a user input unit 130, a sensor unit 140, an output unit 150, a memory 160, an interface 170, a controller 180, and a power supplier 190. Components illustrated in FIG. 2 may not be essential for the terminal 100 and thus, additional or fewer components may be included in the terminal 100.

The components will be further sequentially described hereinafter.

The wireless communication unit 110 may include at least one module that enables wireless communication between the terminal 100 and a wireless communication system or between the terminal 100 and a network in which the terminal 100 is positioned. For example, the wireless communication unit 110 may include a broadcast receiving module 111, a mobile communication module 112, a wireless Internet module 113, a short-range communication module 114, and a location information module 115.

The broadcast receiving module 111 may receive a broadcast signal and information associated with a broadcast from an external broadcast control server through a broadcast channel.

The mobile communication module 112 may transmit and receive a radio signal, on a mobile communication network, with at least one of a base station, an external terminal, and a server. The radio signal may include various forms of data based on transmission and reception of a voice call signal, a video call signal, or a text message/multimedia message.

The wireless Internet module 113 may refer to a module for a wireless Internet access, and be embedded in the terminal 100 or disposed outside of the terminal 100. Technologies for the wireless Internet access may include WLAN, WiFi, WiBro, WiMAX, HSDPA, and the like.

The short range communication module 114 may refer to a module for short range communication. Technologies for the short range communication may include Bluetooth, RFID, IrDA, UWB, ZigBee, and the like.

The location information module 115 may refer to a module for obtaining a location of the terminal 100, and be exemplified by a global positioning system (GPS) module.

The A/V input unit 120 may be used to input an audio signal or a video signal and include a camera 121 and a microphone 122. The camera 121 may process an image frame of a still image or a video obtained by an image sensor in a video call mode or a capturing mode. The processed image frame may be displayed on a display 151.

The image frame processed by the camera 121 may be stored in the memory 160 or transmitted externally through the wireless communication unit 110. Based on an environment in which the camera 121 is used, two or more cameras may be provided.

The microphone 122 may receive an external audio signal in a call mode, a recording mode, a voice recognition mode, and the like, and process the received signal to be electrical audio data. The processed audio data may be converted to a form transmissible to a mobile communication base station through the mobile communication module 112 in the call mode and output. Various algorithms for eliminating noise may be applied to the microphone 122 to eliminate noise generated in a process of receiving the external audio signal.

The user input unit 130 may generate input data for a user to control an operation of the terminal 100. The user input unit 130 may include a keypad dome switch, a resistive or capacitive touchpad, a jog wheel, and a jog switch.

The sensor unit 140 may sense a current state of the terminal 100, for example, a state of opening and closing of the terminal 100, a location of the terminal 100, whether the terminal 100 is in contact with the user, an azimuth of the terminal 100, and acceleration/deceleration of the terminal 100, and generate a sensed signal to control an operation of the terminal 100. For example, when the terminal 100 is provided in a form of a slide phone, the sensor unit 140 may sense whether the slide phone is opened or closed. Also, the sensor unit 140 may sense whether power is provided by the power supplier 190 and the interface 170 is connected to an external device. The sensor unit 140 may include a proximity sensor.

The output unit 150 may generate a visual, an aural, or a tactile output and include a display 151, a sound output module 152, an alarm 153, and a haptic module 154.

The display 151 may display or output information processed by the terminal 100. For example, when the terminal 100 is in the call mode, the display 151 may display a call related user interface (UI) or a call related graphic user interface (GUI). When the terminal 100 is in the video call mode or the capturing mode, the display 151 may display a captured and/or received image, and the UI or the GUI.

The display 151 may include at least one of a liquid crystal display (LCD), a thin film transistor-liquid crystal display (TFTLCD), an organic light emitting diode (OLED), a flexible display, and a three-dimensional (3D) display.

Among the foregoing displays, a display may be provided in a form of a transparent type or a light transmitting type through which an exterior may be viewed. The transparent type or the light transmitting type may be referred to as a transparent display and include a transparent OLED (TOLED). A rear side of the display 151 may also be provided in a light transmitting structure. Due to the structure, the user may view an object positioned behind the terminal 100 through an area occupied by the display 151 in the terminal 100.

Depending on a design of the terminal 100, two or more displays may be present. For example, a plurality of displays may be disposed separately or integratedly on a surface of the terminal 100. Alternatively, each of the displays may be disposed on different surfaces of the terminal 100.

For example, when the display 151 is disposed along with a sensor used to sense a touch (hereinafter referred to as a “touch sensor”) to form a layered structure (hereinafter referred to as a “touch screen”), the display 151 may be used as an input unit in addition to an output unit. The touch sensor may be provided in a form of, for example, a touch film, a touch sheet, and a touchpad.

The sound output module 152 may receive audio data which is received from the wireless communication unit 110 in a call signal reception mode, a call mode, a recording mode, a voice recognition mode, and a broadcast receiving mode or stored in the memory 160. The sound output module 152 may output the audio data associated with functions, for example, a call signal receiving tone and a message receiving tone, performed by the terminal 100. The sound output module 152 may include a receiver, a speaker, and a buzzer.

The alarm 153 may output a signal to inform the user of an event occurring in the terminal 100. The event occurring in the terminal 100 may include reception of a call signal, reception of a message, input of a key signal, input of a touch, and the like. The alarm 153 may output a signal to inform the user of the event through a different form, for example, vibration, other than a video signal or an audio signal. The video signal or the audio signal may be output through the display 151 or the sound output module 152. Thus, the display 151 and the sound output module 152 may be classified as a portion of the alarm 153.

The haptic module 154 may generate various haptic effects that may be perceived by the user. An example of the haptic effects typically generated by the haptic module 154 may be a vibration. An intensity and a pattern of the vibration generated by the haptic module 154 may be controllable. For example, the haptic module 154 may synthesize different vibrations to output a synthesized vibration or output the different vibrations sequentially.

The memory 160 may store a program for an operation of the controller 180, and temporarily store data, for example, a phonebook, a message, a static image, and a video, to be input and/or output. The memory 160 may store data associated with various patterns of vibrations and sounds output upon a touch on a touchscreen.

The memory 160 may include at least one type of storing medium among a flash memory type, a hard disk type, a multimedia card (MMC) micro type, a card type memory (for example, a secure digital [SD] memory and an extreme digital [xD] memory), a random access memory (RAM), a static random access memory (SRAM), a read-only memory (ROM), an electrically erasable programmable read-only memory (EEPROM), a programmable read-only memory (PROM), a magnetic memory, a magnetic disc, and an optical disc. The terminal 100 may operate in association with a cloud server performing a storage function of the memory 160 on the Internet.

The interface 170 may function as a path to all external devices connected to the terminal 100. The interface 170 may receive data from an external device, forward the data to each component in the terminal 100 by receiving power supplied, and allow data in the terminal 100 to be transmitted to the external device. The interface 170 may include a wired and wireless headset port, an external charger port, a wired and wireless data port, a memory card port, a port connecting a device equipped with an identification module, an audio input/output port, a video input/output port, an earphone port, and the like.

The controller 180 may control an overall operation of the terminal 100. For example, the controller 180 may control and process operations in relation to a voice call, data communication, and a video call. The controller 180 may include a multimedia module 181 to play a multimedia. The multimedia module 181 may be included in the controller 180 or disposed separately from the controller 180.

The power supplier 190 may receive external power and internal power applied based on a control by the controller 180 and provide the power required for operations of each component.

The controller 180 may control the wireless communication unit 110 to establish the wireless connection to the vehicular system 200, verify the state of the terminal 100 through the present sensor unit 140 during the wireless connection, and control the wireless communication unit 110 to maintain or cancel the wireless connection based on the state of the terminal 100.

For example, information on the state of the terminal 100 may include information on a motion of the terminal 100 sensed by the sensor unit 140.

The controller 180 may determine whether the driver disembarks the vehicle based on the state of the terminal 100 and control the wireless communication unit 110 to maintain or cancel the wireless connection based on a result of the determining whether the driver disembarks the vehicle.

Also, the controller 180 may determine the strength of the radio signal of the wireless connection, and control the sensor unit 140 to verify the state of the terminal 100 only when the strength of the radio signal is less than or equal to a predetermined value.

FIG. 2B is a block diagram illustrating a configuration of the vehicular system 200 according to an embodiment of the present invention.

Referring to FIG. 2B, the vehicular system 200 may include a wireless communication unit 220 to establish a wireless connection to the terminal 100, a voice processor 240 to process audio data transmitted/received through a speaker or a microphone based on the wireless connection, a sensor unit 230 to sense information on a state of a vehicle when the wireless connection is maintained, a controller 210 to control the wireless communication unit 220 to maintain or cancel the wireless connection based on the sensed information on the state of the vehicle, and an electronic control unit (ECU) 250 to control electronics of the vehicle based on a result of the controlling the wireless connection.

However, components illustrated in FIG. 2B may not be essential for the vehicular system 200 and thus, additional or fewer components may be included in the vehicular system 200. For example, the vehicular system 200 may further include an output unit, a storage, and a user input unit.

The wireless communication unit 220 may establish the wireless connection to the terminal 100 based on the controlling by the controller 210.

The wireless communication unit 220 may include at least one module enabling the wireless communication in a network between the vehicular system 200 and the terminal 100.

For example, the wireless communication unit 220 may include a mobile communication module, a wireless Internet module, a short range communication module, and a location information module.

The mobile communication module may transmit and receive a radio signal with at least one of a base station, an external terminal, and a server in a mobile communication network. The radio signal may include various forms of data associated with a location of the vehicular system 200, a motion signal, a voice call signal, a video call signal, or transmission and reception of a text message and a multimedia message.

The wireless Internet module may refer to a module for a wireless Internet connection, and be embedded in the vehicular system 200 or disposed externally. As described in the foregoing, technologies for the wireless Internet connection may include WLAN, WiFi, WiBro, WiMAX, HSDPA, and the like. Also, technologies for short range communication may include Bluetooth, RFID, IrDA, UWB, ZigBee, and the like.

The location information module may refer to a module for obtaining a location of the vehicular system 200, and be exemplified by a global positioning system (GPS) module.

The user input unit may generate input data for controlling an operation of the vehicular system 200 by the user. The user input unit may include a keypad dome switch, a resistive and capacitive touchpad, a jog wheel, and a jog switch.

The sensor unit 230 may sense a state of electronics connected to the vehicular system 200 and deliver a result of the sensing to the controller 210. The state of the electronics may include a state of opening and closing of a vehicle, a state of whether a driver is seated, a location at which the driver or a passenger enters the vehicle, and a state of acceleration and deceleration of the vehicular system 200.

The sensor unit 230 may sense information of the state of the vehicle during the wireless connection. When the wireless connection does not proceed, the controller 210 may limit a partial or entire operation of the sensor unit 230.

The voice processor 240 may process audio data transmitted and received through the speaker or the microphone of the electronics of the vehicle based on the wireless connection. For example, the voice processor 240 may include a call control signal or a voice signal transmitted and received during a call.

The output unit may generate a visual, an aural, or a tactile output and include a display, a sound output module, an alarm, and a haptic module.

The display may display or output information processed by the vehicular system 200. For example, when the vehicular system 200 is in a steering direction indicating mode, the display may display a UI or a GUI related to an indication of a steering direction.

The display may include at least one of an LCD, a TFTLCD, an OLED, a flexible display, and a 3D display.

When the display is disposed with a touch sensor to form a layered structure or a touch screen, the display may be used as an input unit in addition to an output unit. The touch sensor may be provided in a form of, for example, a touch film, a touch sheet, and a touchpad.

The sound output module may output the audio data processed by the voice processor 240. The sound output module may include a receiver, a speaker, and a buzzer.

The alarm may output a signal to inform the user of an event occurring in the vehicular system 200. The event occurring in the vehicular system 200 may include an emergency, a steering direction, and the like. The alarm may output a signal to inform the user of the occurrence of the event through a different form other than a video signal or an audio signal, for example, a vibration. The video signal or the audio signal may be output through the display or the sound output module. Thus, the display and the sound output module may be classified as a portion of the alarm.

The haptic module may generate various haptic effects that may be perceived by the user in association with a steering apparatus such as a steering wheel and a gear lever connected to the vehicular system 200. The haptic effects generated by the haptic module may be exemplified by a vibration. An intensity and a pattern of the vibration generated by the haptic module may be controllable. For example, the haptic module may synthesize different vibrations of the steering apparatus to output a synthesized vibration or output the different vibrations in sequence.

The storage may store a program for an operation of the controller 210, and temporarily store data, for example, externally sensed data and internally sensed data, to be input and or output.

The storage may include at least one type of storing medium among a flash memory type, a hard disk type, an MMC micro type, a card type memory (for example, an SD memory and an xD memory), a RAM, an SRAM, a ROM, an EEPROM, a PROM, a magnetic memory, a magnetic disc, and an optical disc.

The controller 210 may control an overall operation of the vehicular system 200. For example, the controller 210 may perform control and process in relation to determining a method of the wireless connection, determining a handsfree mode in response to a received call signal, verifying whether the driver or a passenger is on board based on the state of the vehicle, and maintaining and cancelling the wireless connection.

The ECU 250 may control the electronics of the vehicle based on a result of the controlling by the controller 210. The ECU 250 may control the electronics based on the result of the controlling by the controller 210 and provide notifications as to whether the driver enters or disembarks the vehicle, and the wireless connection is to be cancelled or reconnected.

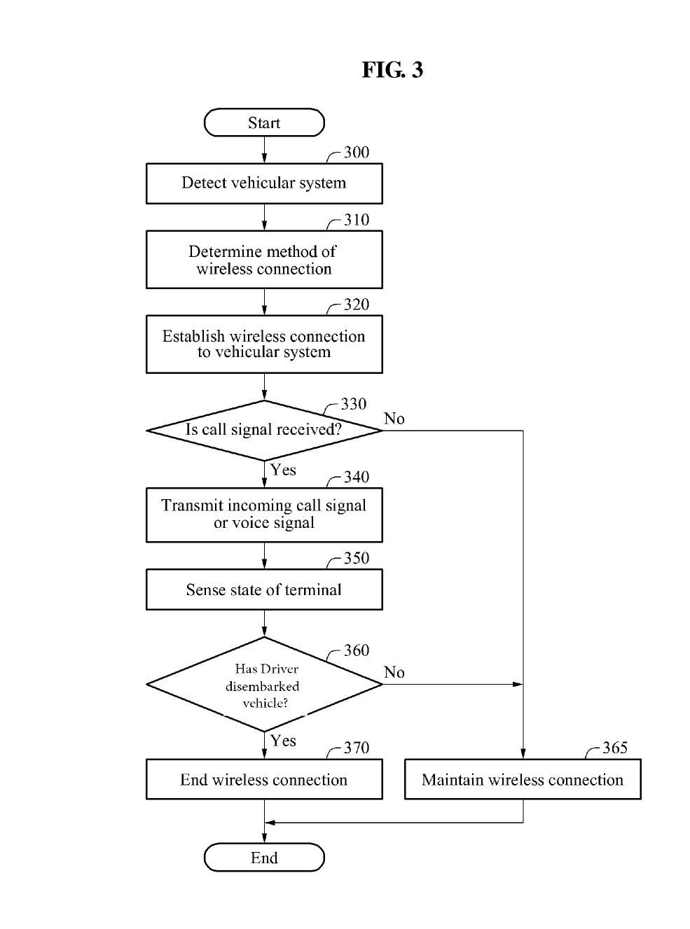

FIG. 3 is a flowchart illustrating an operation method of the terminal 100 according to an embodiment of the present invention.

Referring to FIG. 3, in operation 300, the terminal 100 detects the vehicular system 200.

The terminal 100 may detect a wireless connection that is available to the vehicular system 200 and positioned adjacent to the terminal 100 using the wireless communication unit 120.

In operation 310, the terminal 100 determines a method of the wireless connection to establish the wireless connection to the vehicular system 200 detected in operation 300.

The wireless connection may be one of a short range connection and a wireless Internet connection as described in the foregoing. The controller 180 of the terminal 100 may determine a suitable communication method through communication with the vehicular system 200 prior to the establishment of the wireless connection.

In operation 320, the terminal 100 establishes the wireless connection to the vehicular system 200.

For example, in a case of a Bluetooth connection, the terminal 100 may be interconnected to the vehicular system 200 using predetermined or automatically set pairing data. Also, during the Bluetooth connection, a call signal and a voice signal may be transmitted and received through a radio frequency (RF) communication.

In operation 330, subsequent to the establishment of the wireless connection, the terminal 100 determines whether a call signal is received through a mobile communication network using the wireless communication unit 110 of the terminal 100.

In operation 340, when the call signal is received, the controller 180 may control the output unit 150 of the terminal 100 to display a reception of the call signal, or transmit an incoming call signal or a voice signal to the vehicular system 200. Also, the controller 180 may control the speaker and the microphone of the vehicular system 200 to perform a voice call based on a selective input by a user.

In operation 350, the sensor unit 140 of the terminal 100 may sense a state of the terminal 100.

The sensor unit 140 may sense the state of the terminal 100 during the wireless connection. Sensed data may be output as information on the state of the terminal 100, and the controller 180 may determine whether a driver disembarks a vehicle based on the information on the state of the terminal 100.

The information on the state of the terminal 100 sensed by the sensor unit 140 may include, for example, information on a motion of the terminal 100.

Also, the sensor unit 130 may sense, based on the controlling by the controller 180, the state of the terminal 100 when the wireless connection is maintained and a call connection is maintained.

In general, an issue may arise in process of the call during which the call connection is maintained by the user. According to exemplary embodiments, an apparatus and a method for controlling vehicle communication may solve the issue by suspending a supply of electric power to be consumed for the sensing in a period of time during which the determination of whether the wireless connection needs to be maintained is not significantly required and thus, may increase battery efficiency.

In operation 360, the controller 180 determines whether the driver disembarks the vehicle based on the state of the terminal 100 sensed by the sensor unit 130.

The controller 180 may determine whether the driver using the phone disembarks the vehicle based on the state of the terminal 100.

For example, when a vertical motion of the terminal 100 is determined to be greater than or equal to a threshold based on at least one set of the information on the state of the terminal 100 obtained using at least one of an acceleration sensor, a geomagnetic sensor, and a gyro sensor, the controller 180 may terminate a Bluetooth connection.

The acceleration sensor may refer to a sensor that may measure acceleration and a direction of the acceleration associated with a generated motion. More particularly, the acceleration sensor may output a sensed value corresponding to acceleration due to gravity that varies based on a tilt of a device to which the acceleration sensor is attached. When acceleration sensors are disposed at both edges of the terminal 100, output values sensed by each acceleration sensor may vary due to the motion of the terminal 100. The controller 180 may calculate a pitch angle and a roll angle based on the output values sensed by each acceleration sensor. Accordingly, a direction of the motion of the terminal 100 may be determined based on a variation in the pitch angle and the roll angle detected by each acceleration sensor.

As described in the foregoing, the sensor unit 140 may detect the motion of the terminal 100 using the gyro sensor or the geomagnetic sensor other than the acceleration sensor. The gyro sensor may refer to a sensor to measure a Coriolis force applied towards a direction of a speed of a rotary motion and detect an angular velocity. Based on a value measured by the gyro sensor, a direction of the rotary motion may be detected.

The geomagnetic sensor may refer to a sensor to detect an azimuth using a two-axis fluxgate or a three-axis fluxgate. When the terminal 100 includes the geomagnetic sensor, the geomagnetic sensor disposed at each edge of the terminal 100 may sense a change in a location of the edge and output an electric signal corresponding to a geomagnetic change in response to the change in the location.

The controller 180 may calculate a yaw angle based on a value output by the geomagnetic sensor. Accordingly, various motion characteristics such as a moving direction and a moving speed may be determined based on a variation in the calculated yaw angle.

The sensors described in the foregoing, and configurations and methods of the sensors may be applied to the terminal 100 individually or in combination.

In general, the terminal 100 which is portable may be anchored on a particular location in a vehicle while the vehicle is moving and thus, a vertical motion greater than the threshold may not occur, excluding during a horizontal movement of the vehicle. Thus, when the vertical motion of the terminal 100 is determined to be greater than or equal to the threshold, the controller 180 may terminate the Bluetooth connection and change a mode of the terminal 100 from a handsfree mode to a general call mode.

Also, the terminal 100 which is portable may be anchored on a particular location and thus, a tilt greater than a threshold may not occur. Thus, when the tilt of the terminal 100 is determined to be greater than or equal to the threshold, the controller 180 may terminate the Bluetooth connection and change the mode of the terminal 100 from the handsfree mode to the general call mode.

The terminal 100 may transmit information on the motion of the terminal 100 to the vehicular system 200. The vehicular system 200 may control at least one of the electronics based on the information on the motion of the terminal 100. For example, when the vertical motion of the terminal 100 exceeds the threshold, the vehicular system 200 may receive the information on the vertical motion of the terminal 100 from the terminal 100. The vehicular system 200 may control a communication connection in response to the received information. Also, the vehicular system 200 may control the electronics, for example, by opening or closing a door and controlling an audio system. For example, when a strength of a radio signal between the terminal 100 and the vehicular system 200 is less than a predetermined threshold, the controller 180 may control the terminal 100 to transmit the information on the motion. When the strength of the radio signal between the terminal 100 and the vehicular system 200 is less than the predetermined threshold, the vehicular system 200 may request the information on the motion from the terminal 100.

The vehicular system 200 may determine whether the driver or a passenger disembarks the vehicle based on the information on the motion received from the terminal 100. Also, the vehicular system 200 may control wireless communication or other elements of electronics based on a result of the determining whether the driver or the passenger disembarks the vehicle.

The controller 180 may determine whether the driver disembarks the vehicle based on the wireless communication with the vehicular system 200. For example, when the vehicular system 200 detects that the driver disembarks the vehicle by sensing the state of the electronics of the vehicle or the strength of the radio signal decreases, the controller 180 may determine that the driver is disembarking the vehicle based on the information on the motion detected by the vehicular system 200 or information on whether the driver disembarks the vehicle.

In operation 365, when the driver does not disembark the vehicle or the call signal is not received, the controller 180 may control the wireless communication unit 110 to maintain the wireless connection.

In operation 370, when the driver disembarks the vehicle, the controller 180 may control the wireless communication unit 100 to terminate the wireless connection.

As described in the foregoing, when the driver is determined to disembark the vehicle, the controller 180 may terminate the Bluetooth connection based on the information on the state of the vehicle.

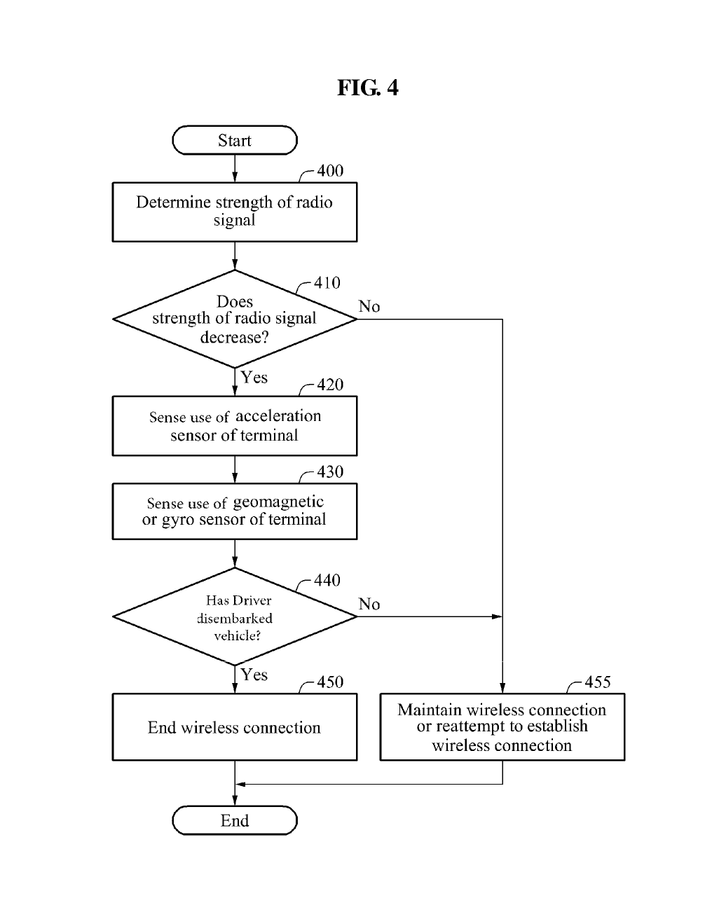

FIG. 4 is a flowchart illustrating an operation method of the terminal 100 according to another embodiment of the present invention.

The controller 180 may determine a distance between the terminal 100 and the vehicular system 200 based on a strength of a radio signal between the terminal 100 and the vehicular system 200.

Here, the distance may not be accurately determined based solely on the strength of the radio signal and thus, exact determination of whether the terminal 100 is located internally or externally may not be easily performed. For example, when the strength of the radio signal is greater than or equal to a predetermined value, the controller 180 may determine that the terminal 180 is located inside of the vehicle, although the controller 180 may not determine whether a user of the terminal 100 is disembarking the vehicle with the terminal 100.

According to embodiments, an apparatus and a method for controlling vehicle communication may improve accuracy in changing a wireless connection mode, for example, a handsfree mode, based on the controlling of the wireless connection using both the information on the state of the terminal 100 and the strength of the radio signal.

The controller 180 may determine whether the driver enters or disembarks the vehicle based on the information on the state of the terminal 100 and determine the distance between the terminal 100 and the vehicle based on the strength of the radio signal. Here, the strength of the radio signal may be used on a preferential basis to reduce power consumption and simplify operations.

When the distance between the terminal 100 and the vehicular system 200 is determined to increase and the driver is determined to disembark the vehicle based on the strength of the radio signal, the controller 180 may terminate the handsfree mode. Accordingly, reliability of an operation of changing the handsfree mode and convenience for user may be improved.

FIG. 4 illustrates an operation of the controller 180.

In operation 400, the controller 180 may determine the strength of a radio signal. In operation 410, the controller 180 may determine whether the strength of the radio signal decreases.

In operation 420, when the strength of the radio signal is determined to be decreasing, the controller 180 may control the sensor unit 140 to sense an acceleration of the terminal 100.

In operation 430, the controller 180 may control the sensor unit 140 to perform the sensing using a geomagnetic sensor or gyro sensor at a predetermined or higher acceleration.

In operation 440, the controller 180 may determine whether the driver enters or disembarks the vehicle based on a result of the sensing.

In operation 450, when the driver is determined to disembark the vehicle as a result of the determining, the controller 180 may terminate the wireless connection.

In operation 455, when the driver is determined to still be on board or the strength of the radio signal is determined not to decrease, the controller 180 may control the wireless communication unit 110 to maintain the wireless connection.

Although when the wireless connection is terminated, the controller 180 may reattempt to establish the wireless connection when the driver is determined to re-enter the vehicle or the strength of the radio signal is determined to increase. Accordingly, a disconnected handsfree mode may be automatically reconnected when the user using the phone re-enters the vehicle and thus, convenience for the user may be further improved.

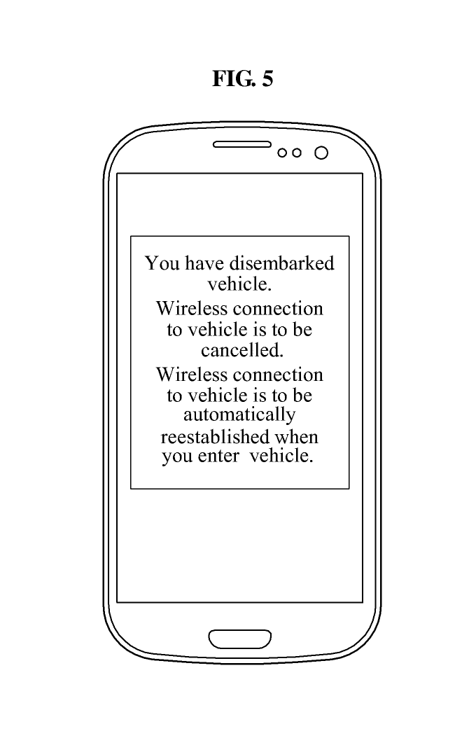

FIG. 5 is a diagram illustrating an example of a display output by the terminal 100 according to an embodiment of the present invention.

Referring to FIG. 5, the terminal 100 may include a display, and output a result of control by the controller 180 as a message through the display. The message may be output in a form of a voice message.

Accordingly, a user of the terminal 100 may be informed of a result of determining whether the user or a driver disembarks a vehicle and a result of controlling the wireless communication unit 110 to maintain or cancel a wireless connection based on the message.

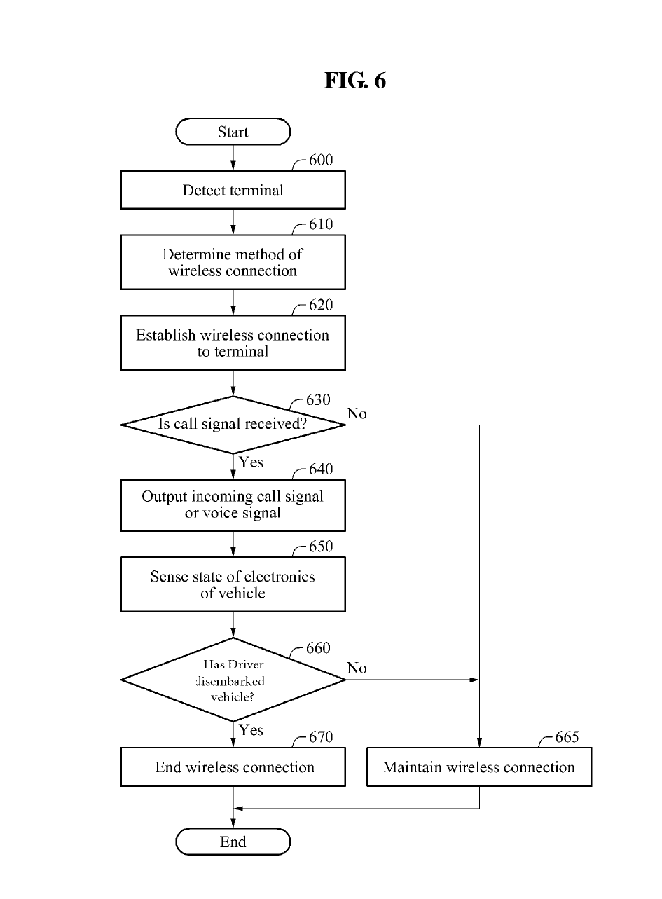

FIG. 6 is a flowchart illustrating an operation method of the vehicular system 200 according to an embodiment of the present invention.

Referring to FIG. 6, in operation 600, the vehicular system 200 detects the terminal 100.

The vehicular system 200 may detect the terminal 100 that is available for a wireless connection and located adjacent to the vehicular system 200 using a wireless communication unit 220.

In operation 610, the vehicular system 200 determines a method of the wireless connection for the wireless connection to the terminal 100 detected in operation 600.

The wireless connection may be one of a short range communication or a wireless Internet connection as described in the foregoing. The controller 210 of the vehicular system 200 may determine a suitable communication method through communication with the terminal 100 prior to establishment of the wireless connection.

In operation 620, the vehicular system 200 establishes the wireless connection to the terminal 100.

For example, in a case of a Bluetooth connection, the vehicular system 200 may be interconnected with the terminal 100 using predetermined or automatically set pairing data. In the Bluetooth connection, a call signal and a voice signal may be transmitted and received through RF communication.

In operation 630, subsequent to the establishment of the wireless connection, the vehicular system 200 determines whether a call signal is received by the terminal 100.

When the call signal is determined to be received by the terminal 100, the controller 210 may control an AVN system of electronics of a vehicle using the ECU 250 to output the call signal. The controller 210 may transmit an incoming call control signal to the terminal 100 based on a selective input by the user and control the speaker and the microphone of the vehicle to perform a voice call. Accordingly, in operation 640, an incoming call signal or a voice signal is output.

In operation 650, the sensor unit 230 of the vehicular system 200 senses a state of the electronics.

The sensor unit 230 may sense the state of the electronics of the vehicle during the wireless connection. The state of the electronics may include at least one of whether a driver is seated, whether a driver side door is opened or closed, whether the vehicle is at rest or in motion, and whether a start button of the vehicle is turned on or off.

The sensor unit 230 may sense the state of the electronics only when the wireless connection and a call connection are maintained. In general, an issue may arise in process of a call during which the call connection is maintained by the user. According to exemplary embodiments, an apparatus and a method for controlling vehicle communication may solve the issue by suspending a supply of electric power to be consumed for the sensing in a period of time during which the determination of whether the wireless connection needs to be maintained is not significantly required and thus, may increase battery efficiency.

In operation 660, the controller 210 determines whether the driver disembarks the vehicle based on the state of the electronics sensed by the sensor unit 230.

According to an embodiment, whether the driver using the phone disembarks the vehicle may be determined based on the state of the electronics. For example, the controller 210 may determine whether the driver disembarks the vehicle based on sensed data received through a proximity sensor or a pressure sensor located on the driver side. Also, the controller 210 may determine whether the driver disembarks the vehicle based on an opening/closing state of the door on the side of the driver's seat.

Also, the controller 210 may determine whether the driver disembarks the vehicle through wireless communication with the terminal 100. For example, when a motion is detected from the terminal 100, the controller 210 may determine that the driver is disembarking the vehicle by receiving information on the motion detected through the wireless communication.

Although illustrative examples described herein feature the driver, the examples may be identically applicable to a passenger on a passenger seat. For example, when the terminal 100 is located on a passenger side, the vehicular system 200 may determine whether the passenger disembarks the vehicle. Accordingly, the sensor unit 230 may sense an open and closed state of a door on the passenger side.

In operation 665, the controller 210 controls the wireless communication unit 220 to maintain the wireless connection when the driver is determined not to disembark the vehicle or a call signal is not received.

In operation 670, the controller 210 controls the wireless communication unit 220 to terminate the wireless connection when the driver is determined to disembark the vehicle.

For example, when the driver is determined to disembark the vehicle based on information on the state of the vehicle, the controller 210 may terminate the Bluetooth connection.

When the driver is determined not to be seated based on the information on the state of the vehicle, the controller 210 may terminate the Bluetooth connection of an AVN system of the vehicle and change a mode of the terminal 100 from a handsfree mode to a general call mode.

Also, when the driver is determined to open a door based on the information on the state of the vehicle, the controller 210 may terminate the Bluetooth connection of the AVN system of the vehicle and change the mode of the terminal 100 from the handsfree mode to the general call mode.

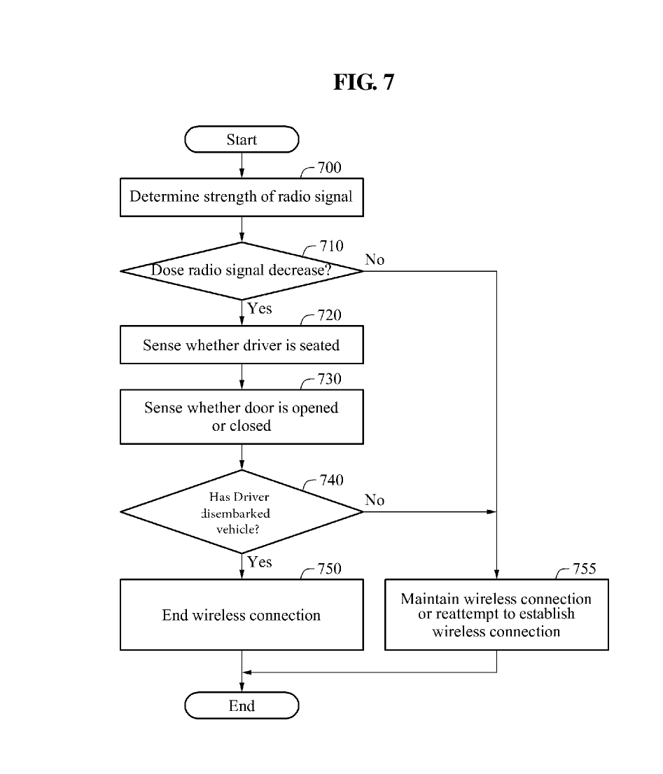

FIG. 7 is a flowchart illustrating an operation method of the vehicular system 200 according to another embodiment of the present invention.

The controller 210 of the vehicular system 200 may determine a distance between the vehicular system 200 and the terminal 100 based on a strength of a radio signal, or a signal of communication with the terminal 100.

However, it may not be accurate to determine whether the terminal 100 is located internally or externally based solely on the strength of the radio signal. For example, the controller 210 may determine that the terminal 100 is located inside of the vehicle when the strength of the radio signal is greater than or equal to a predetermined value. However, the controller 210 may not determine whether a user of the terminal 100 is disembarking the vehicle with the terminal 100.

According to an embodiment, information on the state of the vehicle and the strength of the radio signal may be simultaneously considered and thus, accuracy in changing a mode between a handsfree mode and a general call mode based on control of the wireless connection may be improved.

The controller 210 may determine whether a driver enters or disembarks the vehicle based on the information on the state of the vehicle and simultaneously determine the distance between the vehicular system 200 and the terminal 100 based on the strength of the radio signal. Here, the strength of the radio signal may be determined first to reduce power consumption and simplify operations.

When the distance between the terminal 100 and the vehicular system 200 is determined to increase based on the strength of the radio signal and simultaneously the driver is determined to disembark the vehicle, the controller 210 may terminate the handsfree mode. Accordingly, reliability of changing the mode may increase and convenience for the user may be improved.

FIG. 7 illustrates the operations described in the foregoing of the controller 210.

In operation 700, the controller 210 determines the strength of the radio signal. In operation 710, the controller 210 determines whether the strength of the radio signal decreases.

In operation 720, when the strength of the radio signal is decreasing, the controller 210 controls the sensor unit 230 to sense whether the driver is seated.

In operation 730, the controller 210 controls the sensor unit 230 to sense whether the door is opened or closed.

In operation 740, the controller 210 determines whether the driver enters or disembarks the vehicle based on the sensing.

In operation 750, when the driver is determined to disembark the vehicle, the controller 210 controls the wireless communication unit 220 to terminate the wireless connection.

In operation 755, when the driver is determined to still be on board or the strength of the radio signal does not decrease, the controller 210 controls the wireless communication unit 220 to maintain the wireless connection.

When the driver is determined to re-enter the vehicle after the wireless connection is terminated or the strength of the radio signal is determined to increase, the controller 210 may reattempt to establish the wireless connection. Accordingly, when the user re-enters the vehicle during the call, a disconnected handsfree mode may be automatically reconnected and thus, convenience may be improved for the user.

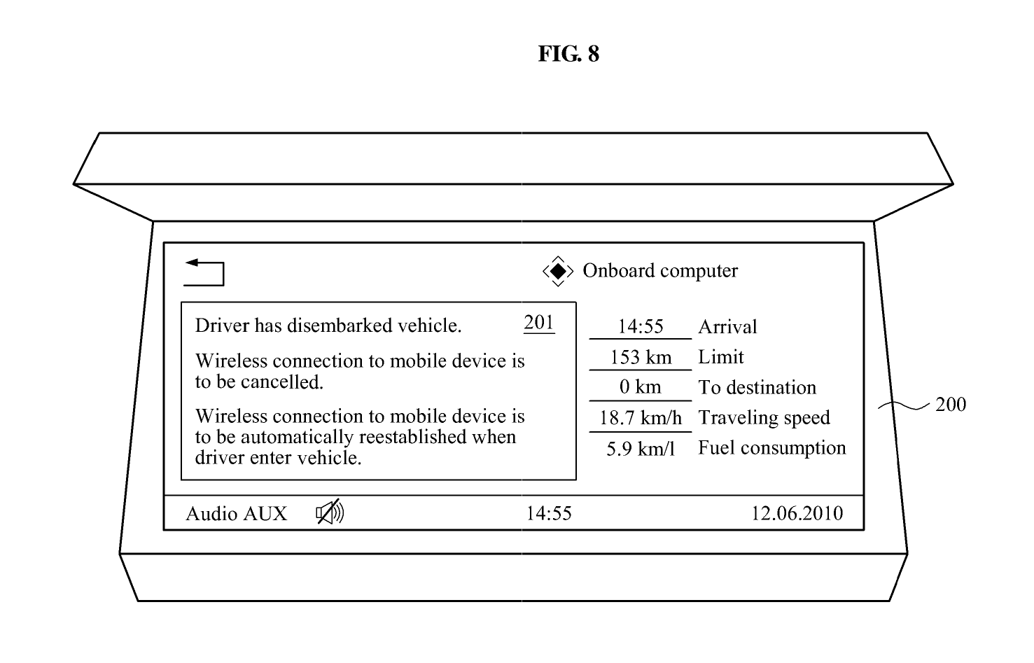

FIG. 8 is a diagram illustrating an example of a display output by the ECU 250 of FIG. 2.

Referring to FIG. 8, the ECU 250 of a vehicle may include an AVN terminal, and output a result of control by the controller 210 of the vehicular system 200 as a message 201 through a display. The message 201 may be output in voice.

Based on the message 201, a user of the terminal 100 may be informed of a result of determination of whether the user or a driver disembarks the vehicle by the controller 210 and a result of control of wireless connection by the controller.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments that accomplish the examples disclosed herein can be easily construed by programmers skilled in the art to which the examples pertain based on and using the flow diagrams and block diagrams of the figures and their corresponding descriptions as provided herein.

As a non-exhaustive illustration only, a terminal or device described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A terminal supporting in-vehicle wireless communication, the terminal comprising:
a wireless communication unit to establish a wireless connection to a vehicular system;
a sensor unit to verify a predetermined state of the terminal when the wireless connection is maintained; and
a controller to control the wireless communication unit to maintain or cancel the wireless connection based on the state of the terminal.

2. The terminal of claim 1, wherein the controller determines whether a driver disembarks a vehicle based on the state of the terminal, and controls the wireless communication unit to maintain or cancel the wireless connection based on a result of the determining whether the driver disembarks the vehicle.

3. The terminal of claim 1, wherein the controller determines a strength of a radio signal of the wireless connection, and controls the sensor unit to exclusively verify the state of the terminal when the strength of the communication signal is less than or equal to a predetermined value.

4. The terminal of claim 1, wherein information on the state of the terminal comprises information on a sensed motion of the terminal.

5. The terminal of claim 4, wherein the controller determines that the driver disembarks the vehicle when a degree of a vertical motion of the terminal exceeds a predetermined threshold.

6. The terminal of claim 4, wherein the controller determines that the driver disembarks the vehicle when a degree of a tilt of the terminal exceeds a predetermined threshold.

7. The terminal of claim 1, wherein the controller controls the wireless communication unit to transmit the information on the state of the terminal to the vehicular system.

8. The terminal of claim 1, wherein the controller determines a strength of a radio signal of the wireless connection, and controls the wireless communication unit to transmit the information on the state of the terminal to the vehicular system when the strength of the radio signal is less than or equal to a predetermined value.

9. A vehicular system wirelessly communicating with a terminal, the vehicular system comprising:
a wireless communication unit to establish a wireless connection to the terminal and receive a predetermined state of the terminal when the wireless connection is maintained; and
a controller to control the wireless communication unit to maintain or cancel the wireless connection based on the state of the terminal.

10. The vehicular system of claim 9, wherein the controller determines whether a driver disembarks a vehicle based on the state of the terminal, and controls the wireless communication unit to maintain or cancel the wireless connection based on a result of the determining whether the driver disembarks the vehicle.

11. The vehicular system of claim 9, wherein the controller determines a strength of a radio signal of the wireless connection, and controls the wireless connection based on the state of the terminal when the strength of the radio signal is less than or equal to a predetermined value.

12. The vehicular system of claim 9, wherein information on the state of the terminal comprises information on a sensed motion of the terminal.

13. The vehicular system of claim 12, wherein the controller determines that the driver disembarks the vehicle when a degree of a vertical motion of the terminal exceeds a predetermined threshold.

14. The vehicular system of claim 12, wherein the controller determines that the driver disembarks the vehicle when a degree of a tilt of the terminal exceeds a predetermined threshold.

15. The vehicular system of claim 9, wherein the controller determines a strength of a radio signal of the wireless connection, and controls the wireless communication unit to request information on the state of the terminal when the strength of the radio signal is less than or equal to a predetermined value.

16. A vehicular system controlling vehicle communication, the vehicular system comprising:
a wireless communication unit to establish a wireless connection to at least one neighboring terminal;
a sensor unit to verify a predetermined state of electronics of a vehicle when the wireless connection is maintained; and
a controller to control the wireless communication unit to maintain or cancel the wireless connection based on the state of the electronics in the vehicle.

17. The vehicular system of claim 16, wherein the controller determines whether a driver disembarks the vehicle based on the state of the electronics of the vehicle, and controls the wireless communication unit to maintain or cancel the wireless connection based on a result of the determining whether the driver disembarks the vehicle.

18. The vehicular system of claim 16, wherein the controller determines a strength of a radio signal of the wireless connection, and controls the sensor unit to verify the state of the electronics of the vehicle when the strength of the radio signal is less than or equal to a predetermined value.

19. The vehicular system of claim 16, wherein the controller determines whether the driver enters the vehicle based on the state of the electronics of the vehicle, and reattempts to establish the wireless connection based on a result of the determining whether the driver enters the vehicle.

20. The vehicular system of claim 16, wherein the state of the electronics of the vehicle comprises at least one of information on a state of doors and seating corresponding to the terminal.
